(19) United States
(12) Patent Application Publication
(10) Pub. No.: US 2007/0222592 A1
(43) Pub. Date: Sep. 27, 2007

(54) Locator-clip for electronic devices

(76) Inventor: Gary M. Zelman, Simi Valley, CA (US)

Correspondence Address: TROJAN LAW OFFICES, 9250 WILSHIRE BLVD, SUITE 325, BEVERLY HILLS, CA, 90212, US

(21) Appl. No.: 11/377,037

(22) Filed: Mar. 15, 2006

(51) Int. Cl. G08B 1/08

(52) U.S. Cl. 340/539.32

(57) ABSTRACT

A holder, such as clip, for a portable electronic device is equipped with a lost device locator function as well as with an out-of-the area alarm function. The out-of-the area alarm is activated when the portable electronic device is beyond a preset distance from the locator clip.

### BACKGROUND OF THE INVENTION

The present invention relates to accessories for hand-held electronic devices. Specifically, the invention discloses a belt clip equipped with a locator for such electronic devices.

Mobile phones and various other hand-held electronic devices, such as, BLACKBERRIES™, personal digital assistants (PDAs), pagers and music players, are often worn on a person's body. For convenience, such electronic devices may also be placed in a special holder or “clip” that attaches to a belt or a purse strap. However, once removed from their holders and used, the electronic devices often become misplaced and lost. The problem gets worse as the technology creates progressively smaller electronic units. Accordingly, it would be desirable to provide the user with a locator, capable of locating the misplaced electronic device. The locator would communicate with the misplaced device, inducing the latter to emit a visible or an audible signal. For additional convenience, an alarm may be provided. If the user moves away from the misplaced device, the locator alone becomes ineffective: the signal emitted by the misplaced device would not be heard or seen. To prevent this, the alarm would alert the user that he is about to leave the area where the misplaced device remains. The user would then commence the search with the locator.

The locator technology is known in the art. For example, many cordless telephones have a locator in the base that sends signals to a misplaced hand piece. Similarly, television sets have locators for misplaced remote control units. The alert devices are likewise known in the art. For example, the U.S. Pat. No. 5,673,035 describes a device for tracking one's property. The device involves a “parent unit” and the “child units”. The “parent unit” remains with the person, while the “child units” are placed, for example, on luggage. The “parent unit” keeps constant communication with the “child units” and alerts the user if such communication has been lost.

It is therefore desirable to provide a locator and alarm unit that would conveniently accompany small hand-held electronic devices. The present invention describes a special holder for a hand-held electronic device with a built-in locator and a distance alarm. For convenience, the holder will be called a “locator clip”.

### SUMMARY OF THE INVENTION

This invention discloses a locator clip for a mobile phone, capable of locating the phone should it become misplaced. The invention further discloses a locator clip for a mobile phone capable of sounding an alarm should the user move away from the misplaced phone beyond a predetermined distance. It is understood that the holder can be modified to serve other electronic devices, such as BLACKBERRIES™, personal digital assistants (PDAs), pagers and music players, either directly or through retrofitting such devices.

In a preferred embodiment the locator clip has a shape of a conventional “clip” or a holster. The locator clip has means for housing the electronic device and means for being attached to a belt, an item of clothing or a purse strap. In another embodiment the locator clip also has a key chain. In addition, the locator clip contains a built-in electronic unit capable of wireless communication with the electronic device over a predetermined distance. The built-in electronic unit includes a power source, a transceiver and an alarm.

Any electronic device may be made compatible with the locator clip through the incorporation of an electronic unit responsive to the electronic unit of the locator clip.

### BRIEF DESCRIPTION OF THE DRAWINGS

FIG. 1A is a front view of one embodiment of the locator-clip.

FIG. 1B is a side view of the embodiment of the locator-clip shown in FIG. 1A.

FIG. 1C is a front view of the embodiment of the locator-clip shown in FIG. 1A having a key chain.

FIG. 2A is a front view of another embodiment of the locator-clip.

FIG. 2B is a side view of the embodiment of the locator-clip shown in FIG. 2A.

FIG. 2C is a front view of the embodiment of the locator-clip shown in FIG. 2A having a key chain.

FIG. 3 is a diagram of a locator unit with one embodiment of a sender, as incorporated into the locator clip.

FIG. 4 is a diagram of a locator unit with another embodiment of a sender, as incorporated into the locator clip.

FIG. 5 is a diagram of a locator unit with one embodiment of a receiver and a distance alarm, as incorporated into the locator clip.

FIG. 6 is a diagram of a locator unit with another embodiment of a receiver and a distance alarm, as incorporated into the locator clip.

FIG. 7 is a diagram of a locator unit with one embodiment of a combination of a sender and a receiver as incorporated into the locator clip.

FIG. 8 is a diagram of a locator unit with another embodiment of a combination of a sender and a receiver as incorporated into the locator clip.

FIG. 9 is a diagram of a locator unit with another embodiment of a combination of a sender and a receiver with three different alarm units as incorporated into the locator clip.

### DETAILED DESCRIPTION OF THE INVENTION

The locator clip of the present invention is a modification of the traditional holder or holster for portable electronic devices. The locator clip has a shape and form that accommodates a particular make and model of the device housed therein. For example, the clip may have a pocket or a bracket in which the electronic device is held. The clip may be made of plastic, metal, leather or a combination thereof. Preferably, the locator unit is placed within the clip so as not to interfere with the insertion and the removal of the device housed in the clip.

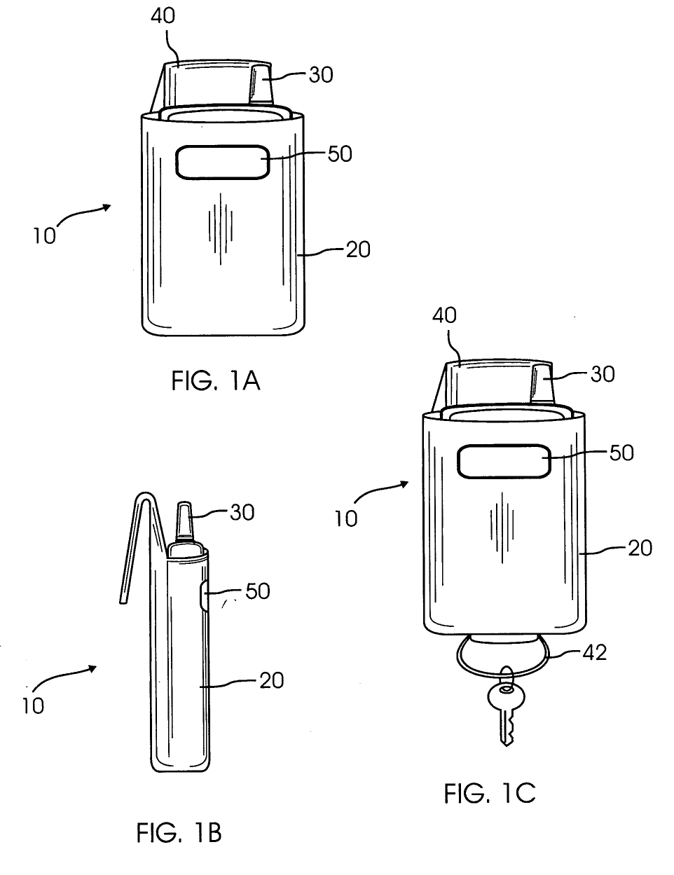

FIGS. 1A and 1B show a front and a side view respectively, of one preferred embodiment of the locator clip. FIG. 1A shows a clip (10) with a pocket (20) for housing the electronic device (30). The clip is attached to the user via an arm (40), better visible on FIG. 1B. The electronic locator unit (50) is placed in the outer wall of the pocket (20).

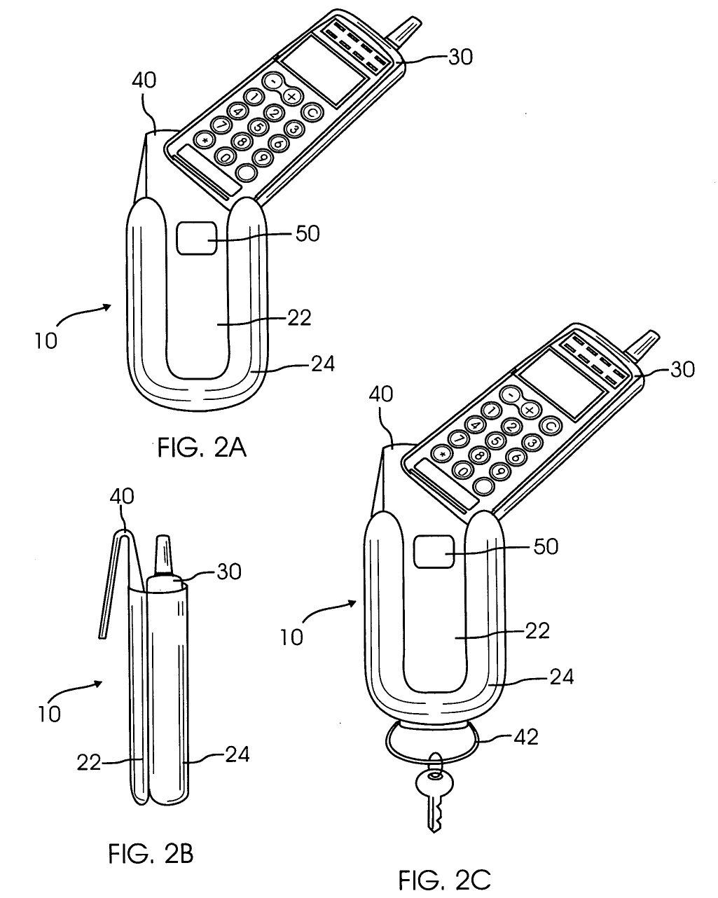

FIGS. 2A and 2B show a front and a side view respectively, of another preferred embodiment of the locator clip. FIG. 2A shows a clip (10) with a plate (22) and a bracket (24) for holding the electronic device. The clip is attached to the user via an arm (40), better visible on FIG. 2B. The electronic locator unit (50) is placed in the plate (22). When the electronic device is removed from its clip, the plate becomes exposed to the exterior.

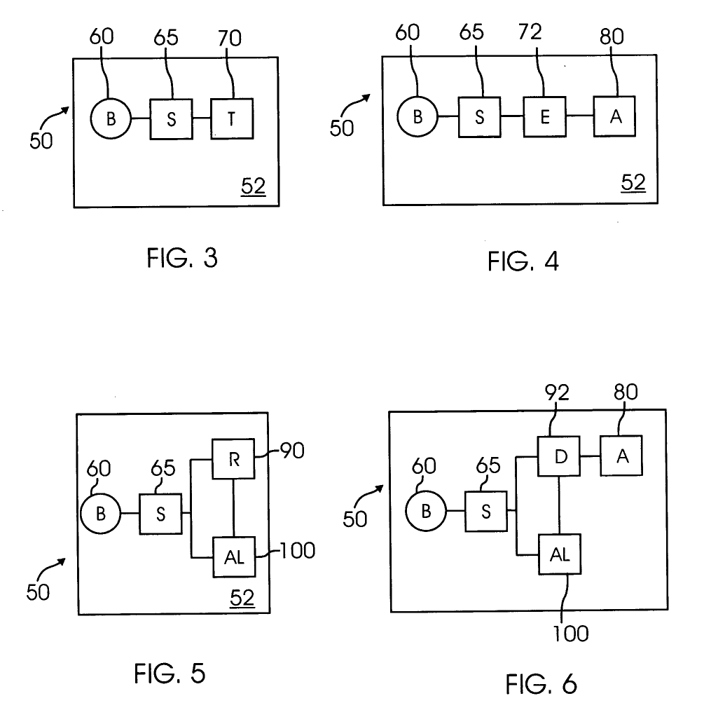

FIG. 3 is a diagram of the locator unit equipped with a sender. The locator unit (50) has a housing (52), preferably made of the same type and color material as the clip itself for better appearance. The parts of the sender include a power source (60), a switch (65) and a transmitter element (70). The power source may be, for example, a conventional, miniature watch battery with the output of 3-12 Volts. FIG. 4 is a diagram of the locator unit (50) with a different configuration of the sender. The sender includes a power source (60), a switch (65), an encoder element (72) and an antenna (80). The transmitter and the encoder may be any commercially available models with an application-specific integrated circuit (ASIC). The sender is programmed to transmit signals of the frequency detectable by the particular electronic device. When the user activates the switch, the sender emits a signal. The misplaced electronic device receives the signal and responds with a beep or a flashing light, utilizing the device's own sound and light capabilities.

FIG. 5 is a diagram of a locator unit equipped with a receiver and a distance alarm. The locator unit (50) has a housing (52), a power source (60), a switch (65), a receiver element (90) and an alarm unit (100). FIG. 6 is a diagram of the locator unit (50) with a different configuration of the receiver. The receiver includes a power source (60), a switch (65), a decoder element (92) and an antenna (80). The receiver and the decoder can be any commercially available models with an ASIC. The receiver is programmed to constantly receive the signals emitted by the electronic device. When the signal is not received (or he intensity of the signal falls below a threshold) because the user has moved away from the misplaced device, the alarm is activated. The alarm may be a sound, a light or a vibration unit. In addition, when the alarm function is not needed, the user has an option of inactivating the system with a switch.

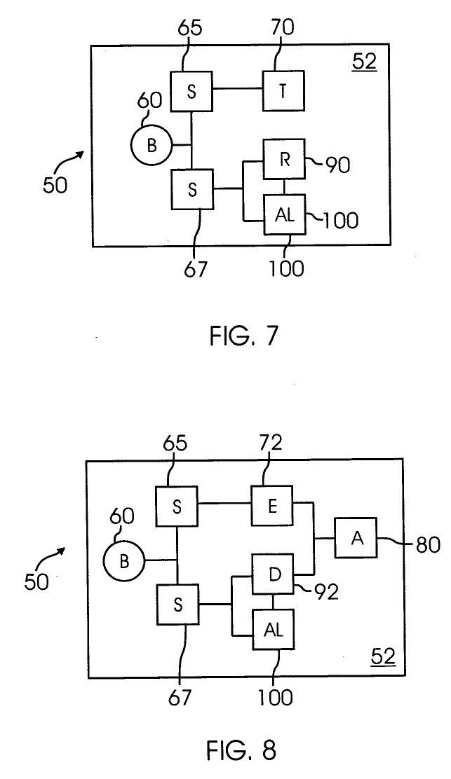

FIG. 7 is a diagram of one embodiment of a locator unit having both a sender and a receiver. The locator unit (50) has two switches (65) and (67), a transmitter element (70), a receiver element (90) and an alarm unit (100). FIG. 8 is a diagram of another embodiment of a locator unit having both a sender and a receiver. The locator unit has two switches (65) and (67), an encoder (72), a decoder (92), an alarm unit (100) and an antenna (80). It is understood that different combinations of the sender and the receiver are possible in a locator clip. The same clip is capable of locating the misplaced electronic device and of alerting the user to the threshold distance to the misplaced device. In addition, the user has an option of selectively activating and deactivating each function.

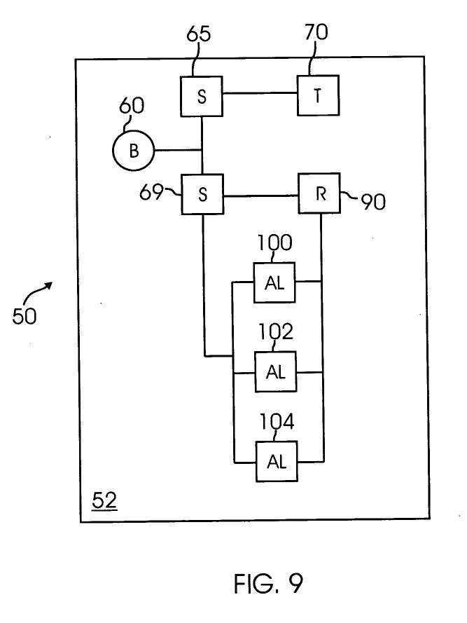

Further, the clip may be equipped with different alarm units. FIG. 9 shows a locator clip with a vibrating (100), an audible (102) and a visible (104) distance alarm. Where several such units are installed in one clip, the user may employ a multi-way switch (69) to select among the several alarm modes.

It is noted, that in some instances, it is possible to program the electronic unit of the locator clip to communicate with the electronic device at a frequency already emitted and receivable by the electronic device. In such instances, no modification of the electronic device is necessary. In other instances, the electronic device must be retrofitted with an element responsive to the communications from the locator clip. As would be apparent to one of ordinary skill in the art, the retrofitter unit on the electronic device would incorporate the transmitter and/or receiver capable of communicating in the frequency range emitted and received by the locator clip.

While the invention has been described in detail and with reference to specific embodiments thereof, it will be apparent to one skilled in electronic arts that various modification can be made within the scope of the invention. Thus the scope of the invention should not be limited by any of the examples described herein.

I claim:

1. A locator clip for a portable electronic device comprising:
a holder for the electronic device;
an electronic sender unit incorporated in said holder, said sender capable of sending wireless communication to said portable electronic device,
wherein said wireless communication results in a perceptible signal emitted by said portable electronic device.

2. The locator clip of claim 1, wherein said sender unit comprises:
a power source, an antenna, an encoder element and a switch,
wherein said sender is capable of sending locator signals to said portable electronic device, and
wherein said locator signals are capable of inducing said portable electronic device to emit a perceptible signal.

3. The locator clip of claim 1, wherein said sender unit comprises:
a power source, a transmitter element and a switch, wherein said sender is capable of sending locator signals to said portable electronic device, and
wherein said locator signals are capable of inducing said portable electronic device to emit a perceptible signal.

4. The locator clip of claim 1 further having a key chain.

5. A locator clip for a portable electronic device comprising:
a holder for the electronic device;
an electronic receiver unit incorporated in said holder, said receiver unit capable of continuously receiving wireless communication from said portable electronic device,
wherein the change in said continuous wireless communication results in a perceptible signal emitted by said locator clip.

6. The locator clip of claim 5, wherein said receiver unit comprises:
a power source, an antenna, a decoder element and an alarm,
wherein said receiver is capable of continuously receiving signals emitted by said portable electronic device, and
wherein the change in said continuous signals is capable of activating said alarm.

7. The locator clip of claim 5 further comprising a key ring, wherein the portable electronic device is used to locate the keys attached to the locator clip.

8. The locator clip of claim 5, wherein said alarm is selected from a group consisting of a sound unit, a light unit and a vibration unit.

9. The locator clip of claim 5, further comprising a selector switch, wherein said alarm is operated by said selector switch and includes more that one unit selected from a group consisting of a sound unit, a light unit and a vibration unit.

10. The locator clip of claim 5, wherein said receiver unit comprises:
a power source, a receiver element and an alarm,
wherein said receiver is capable of continuously receiving signals emitted by said portable electronic device, and
wherein the change in said continuous signals is capable of activating said alarm.

11. The locator clip of claim 10 wherein said alarm is selected from a group consisting of a sound unit, a light unit and a vibration unit.

12. The locator clip of claim 10, further comprising a selector switch, wherein said alarm is operated by said selector switch and includes more that one unit selected from a group consisting of a sound unit, a light unit and a vibration unit.

13. The locator clip of claim 10 further having a key chain.

14. A locator clip system for a portable electronic device comprising:
a holder for the electronic device;
an electronic locator unit incorporated in said holder;
an electronic retrofitter unit incorporated into said portable electronic device;
wherein said locator unit and said retrofitter unit are capable of wireless communication with each other, and
wherein said wireless communication results in a perceptible signal.

15. The locator clip system of claim 14, wherein said electronic locator unit comprises a sender and a receiver.

16. The locator clip system of claim 14 further having a key chain.

17. The locator clip system of claim 14, wherein said retrofitter unit is a sender comprising a transmitter capable of transmitting continuous signals to the locator clip.

18. The locator clip system of claim 14, wherein said retrofitter unit is a sender comprising an antenna and an encoder, capable of transmitting continuous signals to the locator clip.

19. The locator clip system of claim 14, wherein said retrofitter unit is a receiver unit, capable of receiving signals from the locator clip.

20. The locator clip system of claim 14, wherein said retrofitter unit is a receiver comprising an antenna and a decoder, capable of receiving signals from the locator clip.
